(19) United States
(12) Patent Application Publication
(10) Pub. No.: US 2025/0321905 A1
(43) Pub. Date: Oct. 16, 2025

(54) System and Method to Efficiently Assist Time-Synchronous Media Streaming and Remote-Control Applications

(71) Applicant: Microchip Technology Incorporated, Chandler, AZ (US)

(72) Inventors: Michael Rentschler, Karlsruhe (DE); Thorben Link, Karlsruhe (DE); Karl Erik Andreas Törner, Nodinge (SE); Eric Matthew Ching, Austin, TX (US); Atsushi Horio, La Jolla, CA (US)

(73) Assignee: Microchip Technology Incorporated, Chandler, AZ (US)

(21) Appl. No.: 18/937,232

(22) Filed: Nov. 5, 2024

Related U.S. Application Data
(60) Provisional application No. 63/634,656, filed on Apr. 16, 2024.

(51) Int. Cl. G06F 13/16; G06F 13/28

(52) U.S. Cl. CPC G06F 13/1673; G06F 13/1689; G06F 13/28

(57) ABSTRACT

An apparatus is provided comprising a buffer in direct memory access communication with a network interface to receive data packets comprising data payload portions containing data in a stream of time-synchronous media, a buffer to temporarily store a plurality of time-synchronous media records extracted from the data payload portions, wherein respective ones of the plurality of time-synchronous media records is associated with a respective media channel, a data router circuit to read one of the plurality of time-synchronous media records from the buffer route that time-synchronous media record to a media interface, and a buffer monitor circuit to monitor a ratio of stored records and read records and to trigger a processor interrupt in the event of a buffer underflow or buffer overflow.

### RELATED APPLICATIONS

This application claims priority to U.S. provisional application Ser. No. 63/634,656, filed on Apr. 16, 2024, the disclosure of which is incorporated by reference in its entirety for all purposes.

### FIELD OF THE INVENTION

The present application relates to systems and methods for efficiently processing time-synchronous media in a streaming environment, for example streaming of audio, video, or sensor data.

### BACKGROUND

Streaming time-synchronous data in a networked environment presents challenges. Data must be handled with a close watch over timing and with care to process data as it is produced and/or consumed. Some data types may be amenable to pausing, muting, or repeating values to maintain an end-user experience in the event of a buffer overrun or underrun.

### SUMMARY

In some examples, an apparatus comprises a buffer in direct memory access (DMA) communication with a network interface to receive data packets comprising data payload portions containing data in a stream of time-synchronous media, a buffer to temporarily store a plurality of time-synchronous media records extracted from the data payload portions, wherein respective ones of the plurality of time-synchronous media records is associated with a respective media channel, a data router circuit to read one of the plurality of time-synchronous media records from the buffer route that time-synchronous media record to a media interface, and a buffer monitor circuit to monitor a ratio of stored records and read records and to trigger a processor interrupt in the event of a buffer underflow or buffer overflow. In some examples, the apparatus comprises a timestamp matching circuit, comprising a timestamp window representing a minimum timestamp value and a maximum timestamp value, a timestamp register to record a time value corresponding to a most recent frame synchronization signal, and a matching circuit to assert a match signal when the time value corresponding to the most recent frame synchronization signal is within the timestamp window. In some examples, the timestamp matching circuit comprises a first counter to increment on each operation of the matching circuit, and a latched counter to increment on each assertion of the match signal. In some examples, the timestamp matching circuit comprises a reset circuit to reset the first counter and the latched counter, and to set a trigger to enable the first counter on a next assertion of the match signal. In some embodiments, the data router circuit comprises a first DMA input associated with a first media channel to receive a first time-synchronous media record from the buffer, a second DMA input associated with a second media channel to receive a second time-synchronous media record from the buffer, an unpacker circuit for receiving a third time-synchronous media record from the buffer, the unpacker circuit comprising a first unpacker output to output a first subset of the third time-synchronous record, and a second unpacker output to output a second subset of the third time-synchronous record, a first input selector to select either the first DMA input or the first unpacker output, and a second input selector to select either the second DMA input or the second unpacker output. The apparatus of claim 5, the data router circuit comprising a gate closed input, a first gate selector to select either the output of the first input selector or the gate closed input based on a first gate control signal, and a second gate selector to select either the output of the second input selector or the gate closed input based on a second gate control signal. In some embodiments, the data router circuit comprises a first padding mask circuit to controllably mask zero or more bits of the output of the first gate selector, a second padding mask circuit to controllably mask zero or more bits of the output of the second gate selector, and a routing selector to route to an output register one of an output of the first padding mask circuit, an output of the second padding mask, and a null value.

In some examples, a method is provided comprising receiving a first time-synchronous media record containing data in a stream of time-synchronous media, storing the first time-synchronous media record in a buffer with a media channel identifier and associated with a timestamp, monitoring the buffer with a buffer monitor circuit to trigger a processor interrupt in the event of a buffer underflow or buffer overflow, determining the timestamp to be within an acceptable timestamp window and routing the first time-synchronous media record from the buffer to a media interface using a data router circuit, wherein the routing is based at least in part on the media channel identifier. In some examples, the method comprises incrementing a first counter on each occurrence of storing the data payload in the buffer, and storing the first counter in a latched counter on each occurrence of determining the timestamp to be within an acceptable timestamp window. In some examples, the method comprises resetting the first counter and the latched counter, and setting a trigger for enabling the first counter on a next occurrence of determining the difference between the current time and the timestamp to be less than the window. In some examples, the method comprises receiving, at a first DMA input associated with a first media channel, a first time-synchronous media record from the buffer, receiving, at a second DMA input associated with a second media channel, a second time-synchronous media record from the buffer, based on an input selector, selecting the second time-synchronous record to proceed through a routing circuit, and subsequent to outputting the second time-synchronous record, selecting the first time-synchronous record to proceeded through the routing circuit. In some examples, the method comprises receiving, at a first DMA input associated with a first media channel, a first time-synchronous media record from the buffer, based on a packer configuration input, selecting a first portion of the first time-synchronous media record to proceed through a routing circuit, selecting by a first gate selector to route either a gate closed input or the first portion of the first time-synchronous record to proceed through a routing circuit, and subsequent to selecting the first portion of the first time-synchronous media record to proceed through the routing circuit based on the packer configuration input, selecting a second portion of the first time-synchronous media record to proceed through the routing circuit. In some examples, the method comprises controllably masking eight or more bits of the first portion of the first time-synchronous record to generate a padded record, and outputting the padded record to a media device.

In some examples an apparatus is provided comprising, a buffer in direct memory access (DMA) communication with a network interface to send data packets comprising data payload portions containing data in a stream of time-synchronous media, a buffer to temporarily store a plurality of time-synchronous media records to be included in data payload portions, wherein respective ones of the plurality of time-synchronous media records is associated with a respective media channel, a data router circuit to route data between a media interface and the buffer, and a buffer monitor circuit to monitor a ratio of stored records and read records and to trigger a processor interrupt in the event of a buffer underflow or buffer overflow. In some examples, the apparatus comprises a channel selector to route a data record from the media interface to one of a plurality of media channel registers, each media channel register in DMA communication with the buffer. In some examples, the apparatus comprises a plurality of padding mask circuits each padding mask circuit to controllably mask zero or more bits of a particular data record from the media interface before storing the padded data record in associated with one of the plurality of media channel registers. In some examples, the apparatus comprises a packer circuit in communication with the channel selector to combine at least a portion of each of two data records received from the media interface and to store the combination in one of the plurality of media channel registers.

In some examples, a method is provide comprising receiving a data record from a media device, the data record forming a portion of a stream of time-synchronous media, routing the data record over a DMA channel to store the data record in a time-synchronous media buffer the time-synchronous media record associated with the media stream, and monitoring the buffer with a buffer monitor circuit to trigger a processor interrupt in the event of a buffer underflow or buffer overflow. In some examples, the method comprises selecting a channel to route a time-synchronous media record from the media interface to one of a plurality of media channel registers, each media channel register in DMA communication with the buffer. In some examples, the method comprises controllably masking zero more bits of the data record. In some examples, the method comprises packing at least a portion of each of two data records received from the media device and storing the combination in one of the plurality of media channel registers.

### BRIEF DESCRIPTION OF THE DRAWINGS

FIG. 1 is a diagram of a system for transferring streaming data from a network to a media interface (or in reverse), according to certain examples of the present disclosure.

FIG. 2 is a diagram of a portion of the system for transferring streaming data from a network to a media interface (or in reverse), according to certain examples of the present disclosure.

FIG. 3 is a diagram of an out-bound data router (combiner) block, according to certain examples of the present disclosure.

FIG. 4 is a diagram of an in-bound data router (combiner) block, according to certain examples of the present disclosure.

FIG. 5 is a diagram of a buffer monitor, according to certain examples of the present disclosure.

FIG. 6 is a diagram of a clock management circuit, according to certain examples of the present disclosure.

FIG. 7 is a diagram of a circuit for transferring streaming data from a network to a media interface (or in reverse), according to certain examples of the present disclosure.

### DETAILED DESCRIPTION

Certain products such as professional audio, industrial, and automotive may benefit from cost-effective interfaces to time sensitive networks such as audio/video bridging. Specialized circuitry can buffer and route data between a network interface and a media interface to allow efficient dataflow with continuous monitoring of data streams. Applications include automotive networks with devices coupled to a 10BASE-TIS network, Time Sensitive Network Audio Visual Transport Protocol (IEEE 1722), and Real Time Transport Protocol (RFC 3550). Other applications include allowing time-synchronous peripheral access remotely through a network according to Open Alliance TC14 Remote Control or other similar protocols. Further applications include time-synchronization according to gPTP (IEEE 802.1as) or other time-synchronization protocols. The present disclosure allows offloading of time-sensitive tasks from a CPU and simplifies software requirements in a time-sensitive processing environment. This increases product capabilities and efficiency while reducing product costs.

Streaming data over a network requires synchronized time between the source and presentation nodes on the network. Synchronization may be performed via gPTP or similar protocol. A talker receives data as a synchronous bit stream (e.g., audio, video, real-time sensor data). The talker may be receiving the data from a sensor or from storage. The talker packetizes the data with timestamp information and transmits that data through the network to a listener. The listener receives packetized data into a packet buffer. The packets are processed to extract the timestamps and the payload data. The payload data is added to a buffer as part of a synchronous data stream. A time shift results from network delays and buffering, but the resulting data stream should flow at the time synchronous rate at which it was encoded/captured. The system can monitor the timestamp associated with each data block to determine whether the data stream is flowing at the predetermined rate. A buffer underflow occurs when insufficient data is arriving at the listener and a buffer overflow occurs when too much data is arriving at the listener. In either case, the listener will be unable to present the data properly.

Examples of streaming data include audio from a microphone or recorded source. Video may include matrix video data for display inside the vehicle and may include low resolution LED patterns for turn signals or brake lights in a vehicle.

Examples provided are discussed with reference to the figures.

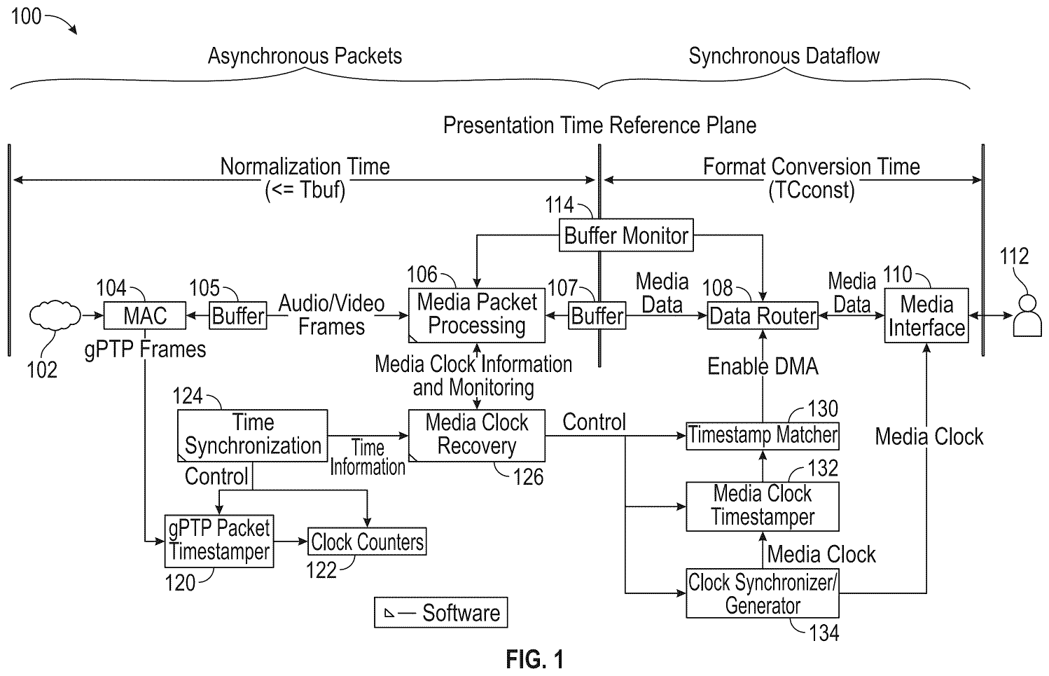

FIG. 1 is a diagram of system 100 for transferring streaming data from a network to a media interface (or in reverse), according to certain examples of the present disclosure. System 100 comprises two portions. This figure illustrates a listener application with ultimate presentation via media interface 110 to user 112. The left portion of FIG. 1 operates asynchronously on packets as they arrive and depart. The right portion operates synchronously on standardized units of data. The vertical line represents the junction between the asynchronous packet domain and the presentation domain. The left and right portions of FIG. 1 may be synchronized via a global clock synchronization protocol (e.g., gPTP) that synchronizes nodes on a network. In some examples, a single network node is primary (e.g., a clock master) and other nodes are synchronized with that primary network node. In some examples, redundant clock sources may provide synchronization for network nodes.

A packet includes header and payload portions. For incoming packets, the payload is extracted and stored in a buffer for handoff to the presentation domain. Data may be transferred bidirectionally in some applications. In system 100, each data block may be serially processed at an evenly distributed clock rate. In some applications, only the start of frames (e.g., one frame of a video stream) may be present at a synchronous rate.

In one example, a car may include an auxiliary audio jack for connecting to a cellular phone. The audio jack may provide for two incoming audio channels (stereo L and R) and one outgoing audio channel carrying the microphone data from a microphone embedded in the headline of the car. Audio data is time-sensitive because early or late arrival of audio data will alter the playback or sample frequency of the data and will result in a change in pitch, cause pops or silence, or otherwise alter the quality of sound.

Packetized data may arrive via network 102 at media access controller 104. Packetized data may be sorted as media data to be buffered for ultimate consumption by media interface 110 and as control data for synchronizing clock information and controlling presentation of the media. Time protocol data frames may be routed by MAC 104 to gPTP Packet Timestamper 120, which may read clock counters 122 as data arrival is timestamped. Clock counters 120 may represent the node's real time clock and a local synchronized clock. Time synchronization module 124, shown here as a software module, may implement a global time synchronization protocol to maintain a real time clock synchronized with other devices on network 102. Media clock recovery module 126 may interact with media packet processing module 106 to exchange media clock information and information used to monitor the flow of data and related timing information. Media clock recovery 126 may provide control signals to timestamp matcher 130, media clock timestamper 132, and clock synchronizer/generator 134. Clock synchronizer/generator 134 may receive timing information from media packets to generate a media clock that is synchronized with the global real time clock. Clock synchronizer/generator 134 may adjust the media clock timing to skew presentation earlier or later in time as an application may demand.

Media packet processing module 106, shown here as a software module, may provide high-level operational control over the flow of data through system 100. Media packet processing module 106 controls transfer of data from MAC 104 (and associated packet buffer 105) to buffer 107 and from buffer 107 to MAC 104. Media packet processing module 106 performs a DMA transfer to read a media packet from packet buffer 105. Media packet processing module 106 may extract time synchronous data and timing information from the media packet and copy the time synchronous data to a time-synchronous media record in buffer 107 via DMA transfer.

In a listener operation, e.g., where data is received from the network and provided to the media device, media packet processing module 106 may be responsible for stream validation, timestamp processing (including presentation time processing), and media processing (if any), as well as configuration of the DMA operations, data router circuit (combiner), and buffer monitor. Media packet processing module 106 may also consume and monitor the media clock recovery state to control and modify the media data flow in cases of clock recovery anomalies and errors. Media packet processing module 106 may process incoming screened and filtered network packets based on an expected stream packet format from the network and may be configured according to the use case, e.g., audio/video listener (network to media device). The configuration could be according to standard protocols such as RTP/RTCP or AVTP 1722. Or could be other similar well-defined Ethernet packet formats. In a talker operation, e.g., where data is received from the media device and sent over the network, media packet processing module 106 may be responsible for stream packetization and sequencing, timestamp processing (including presentation time processing), and media processing (if any), as well as configuration of the DMA operations, data router circuit (splitter) if needed, and buffer monitor. Media packet processing module 106 may also consume and monitor the media clock recovery state to control and modify the media data flow in cases of clock recovery anomalies and errors. Media packet processing module 106 may process incoming media channels based on an expected stream packet format to be transmitted to the network and is configured according to the use case, e.g., audio/video talker (media device to network). The configuration could be according to standard protocols such as RTP/RTCP or AVTP 1722. Or could be other similar well-defined Ethernet packet formats.

Media clock recovery 126 may consume time synchronization status information and configure/control timestamp matcher 108, media clock timestamper 130, and clock synchronizer/generator 134.

In some examples, there is a well-known and pre-defined format of data received or transmitted to the network. The data payloads of these packets may contain time-synchronous media data received as a stream of packets, e.g. audio/video channel(s), frames, or lines (in the case of video). Packet formats may be defined by standardized network protocols such as RTP/RTCP or AVTP 1722. The media packet processing 106 may configure and monitor the data flow of the hardware circuits based on expected payload media data ordering. Ethernet packets may contain standard headers in addition to protocol headers of RTP/RTCP or AVTP in addition to the media data. The media data may be processed by media packet processing 106. Timestamps may be separate from the media data and used for the media clocking and presentation time processing such that media data in the buffer can be matched with the associated time information.

Data router 108 is a hardware circuit to control data transfers from buffer 107 to media interface 110 for presentation to user 112, for example audio playback through the car stereo system via a digital to analog converter (DAC). Media interface 110 may also capture audio from user 112 via a microphone and analog to digital converter (ADC). In some examples, media interface may drive an LED display such as a multi-segment directional indicator on a car. In some examples, media interface may capture sensor data on a regular interval. Data router 108 may control data transfers from media interface 110 to buffer 107 to be packetized and transferred over network 102. In some examples, data router 108 may operate to combine data from multiple data streams for delivery to a single media interface 110. For example, high-fidelity audio may be streamed across network 102 including two 24-bit audio channels (left and right). Data router 108 may deliver a time-synchronous media record for the left channel to media interface 110 followed by a time-synchronous media record for the right channel followed by a time-synchronous media record for the left channel and so on. In some examples, media interface 110 may be responsible for delivering the time-synchronous media records to digital to analog converters (DAC) that feed an audio amplifier. In some examples, more than two audio channels may be combined for delivery to media interface 110. In some examples, audio data may be 16-bit samples. In some examples, audio data may be 8-bit samples. Data router 108 may pass a time-synchronous media record if that record has a timestamp within an acceptable time window, as determined by timestamp matcher 130. In some examples, data router 108 may pass null data in some circumstances if no new time-synchronous media record is available to be read from buffer 107 or if the next time-synchronous media record does not have a timestamp within the allowable window. In some examples data router 108 may repeat the value of the previous time-synchronous media record in the event of a buffer underflow or in the event of a failed timestamp match. In some examples, a media clock pulse may trigger data router 108 to process one time-synchronous media record for each configured channel. This may, for example, result in presentation of a left and then a right audio channel value to media interface 110. In some examples, a media clock pulse may trigger data router 108 to process a frame of data (e.g., a predetermined number of time-synchronous media records) for a configured channel.

In some examples, data router 108 may distribute (or split) time-synchronous media records from media interface 110 across multiple channels. For example, media interface 110 may capture 24-bit audio samples from multiple microphones in an automobile. Data router 108 may capture each sample and route it to an appropriate channel to be stored in buffer 107 for subsequent streaming over network 102. For example, in a two-channel system, data router 108 may route a first sample to a first channel, a second sample to a second channel, the third sample to the first channel, and so on. Each sample may be associated with timing information, e.g., a current timestamp. In some examples, a media clock pulse may trigger data router 108 to distribute one value received from media interface 110 to a time-synchronous media record associated with a channel in buffer 107.

Buffer 107 may be implemented with multiple single-channel buffers or a single multi-channel buffer or some combination of buffers. Each time-synchronous media record may be associated with a channel. For example, all left audio channel records may be associated with a first channel in a multi-channel buffer 107. In this example, all right audio channel records may be associated with a second channel in the multi-channel buffer 107. DMA transfers in or out of buffer 107 may address a specific channel.

Media clock recovery 126 may provide control information to timestamp matcher 130, media clock timestamper 132, and clock synchronizer/generator 134. This timestamp information may be used to identify issues with the real time data stream that may trigger the need for a media playback restart, muting, or other error correction/recovery approaches. Clock synchronizer/generator may also feed a media clock to media interface 110 to maintain time synchronization. In some examples, blocks marked with a triangle in the lower left corner may be implemented in software executing on a processor. In some examples, all other blocks may be implemented in hardware to operate continuously and independently of the current operation of the processor.

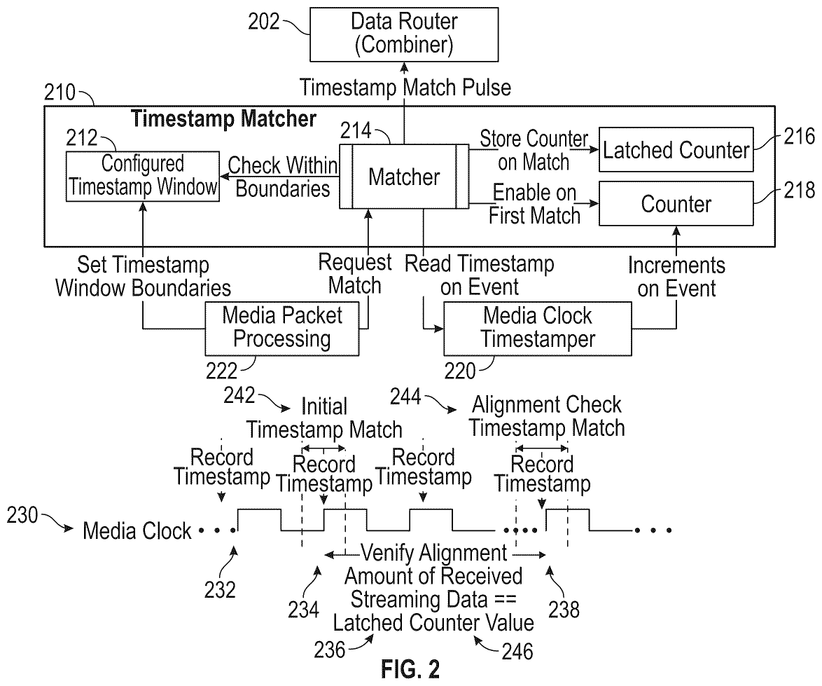

FIG. 2 is a diagram of subsystem 200 for transferring streaming data from a network to a media interface (or in reverse), according to certain examples of the present disclosure. Data router (combiner) 202 organizes and rearranges data from a buffer format to a presentation format and vice versa. One input to Data router 202 is a timestamp match pulse that signals the availability of properly timed data to be transferred to or from the buffer.

Timestamp matcher 210 may perform data synchronization and monitoring to reduce processor load. In some examples, timestamp matcher offloads accurate media presentation and monitoring. More specifically, timestamp matcher 210 matches a recorded media clock timestamp with a preset timestamp window. Timestamp matcher 210 initiates a signal upon a match event prompting data router (combiner) 202 to commence the data routing (combining) process. Timestamp matcher 210 may also verify timestamp alignment by counting timestamp record events and by capturing an event count when timestamps match. Timestamp matching features may enable system 100 to meet requirements on data presentation time with media clock accuracy. In some examples, the time sensitive data may be sensor data, video data, or audio data. Software blocks in system 100 may monitor timing requirement compliance observed by the timestamp alignment features of the present disclosure. Alignment may be verified by evaluating the variance in the amount of received streaming data and the event count disparity between two match events.

In one scenario, a new data stream is to be initiated. Control information may specify a start time. Presentation may begin when synchronous data has been buffered and the presentation start time aligns with a media clock. Start times may be governed by boundaries set in a standard, for example the IEEE 1722-2016 Audio/Video Transport standard. If the buffer is full and ready to start streaming, media packet processing 222 may enable streaming at the specified presentation start time. Media packet processing 222 may enable streaming by signaling data router 114.

In a second scenario, a data stream is running and must be monitored by media packet processing 222. To aid the software monitor, timestamp matcher 210 relies on matcher block 214 to confirm that each record timestamp is within the timing boundary. When the first match occurs at the start of a data stream, matcher block 214 may enable counter 218, which increments each time media clock timestamper 220 records a timestamp. Timestamp window 212 may store a minimum allowable timestamp value and a maximum allowable timestamp value set based on the current timing requirements of the real-time application. For example, the minimum and maximum allowable timestamp values may allow for a certain amount of timing variance that may be imperceptible to the human car in a particular environment (e.g., a car stereo).

On each occasion that time matcher block 214 confirms a recorded timestamp is within boundaries defined by configured timestamp window 212, matcher block 214 stores the current counter value latch counter 216. Media packet processing 222 may read the latched counter to verify present time alignment. Media packet processing 222 may at any time compare the values of latched counter 216 and counter 218 to determine whether timing errors have occurred since media packet processing 222 last observed the counters. Timestamp matcher 210 may analyze each data transfer. Counter 218 may be configured to report an error if it wraps around twice. Misalignment may occur due to clock drift or some other error. When misalignment occurs, media packet processing 222 may stop the data stream and reestablish the stream. In some examples, a minor alignment error or an infrequent error may be noted for later diagnosis without the need to stop and restart the stream. Continual monitoring may not be required by the standard but provides robustness in solutions. In some examples, some or all of media packet processing 222 could be implemented in hardware to allow real-time monitoring of timing errors. In some examples, the alignment tolerance may be varied based on the use case. The match request may be part of the stream alignment processing step as follows. Timestamps from the media stream may be determined to be valid and stable as part of the stream validation processing. A next current timestamp may be used to determine a presentation time. Window boundaries may be calculated based on the configured tolerance for the media stream. The matcher may compare the media clock timestamp within the window (indirectly this is a comparison against the expected presentation time). The synchronous data may be enabled once there is a first match. (Timestamps from the stream may also be used by the media clock recovery 606 to setup and generate the media clock in the clock synchronizer/generator that is timestamped by the media clock timestamper.)

Media clock 230 is illustrated with record timestamp events 232, 234, 236, and 238. Time window 242 represents an initial timestamp match. Time window 244 represents an alignment check of timestamp match after the data stream has been running. Monitoring event 246 verifies alignment by comparing the amount of streaming data to latched counter value 216.

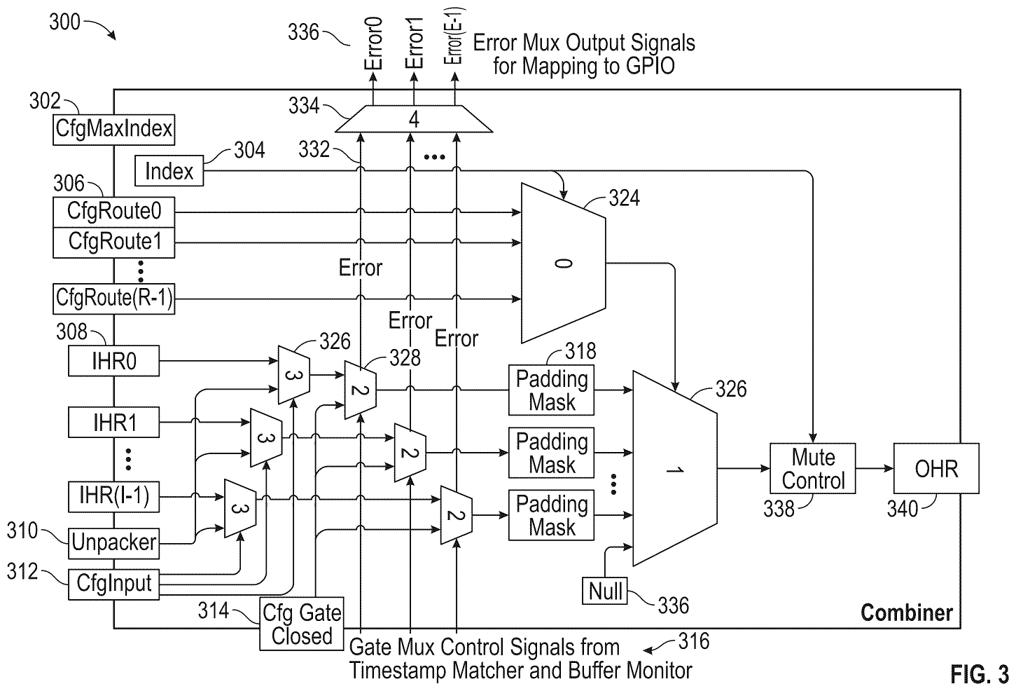

FIG. 3 is a diagram of an out-bound data router (combiner) block, according to certain examples of the present disclosure. For case of reading, the data router (combiner) block may be referred to as data router or data combiner. Data router circuit 300 enables integration of data from multiple network streams into the same peripheral interface without software involvement. Data router circuit 300 may be completely driven by peripheral DMA transactions. Data router circuit 300 may be synchronized with the start of streaming driven by timestamp matcher 210 (not shown in FIG. 3). Data router circuit 300 may also perform real-time error handling in communication with buffer monitor 114. Data router circuit 300 may incorporate data value manipulation and reordering. The output holding register (OHR) of data router circuit 300 may be connected via a DMA channel to a transmit holding register (THR) of a peripheral (not shown). A DMA channel connects, for example, a data channel stored in a data buffer (e.g., buffer 107) with one of the input holding registers (IHRₙ) 308 of data router circuit 300. Each IHRₙ 308 may be associated with a specific channel of time-synchronous media records and may be associated with a specific DMA channel number. For example, IHR0 may be assigned a first DMA channel that is also associated with a first channel of time-synchronous media records in the buffer. Each refill event for IHR0 may trigger a DMA read request from the buffer from the associated channel to obtain the next time-synchronous media record for that channel. IHR1 may be assigned a second DMA channel associated with a second channel of time-synchronous media records in the buffer. Where the system maps a specific DMA channel number to a channel of media records a buffer monitor may track the number of DMA reads and writes to determine whether the buffer for that channel of media records has an underflow or overflow condition.

Configuration registers CfgMaxIndex 302, Index 304, and CfgRouten 306 provide control over the operation of an out-bound data router circuit 300. CfgMaxIndex 302 provides a bound of the number of possible index values. For example, a configuration transferring two-channels of audio to OHR 340 may set CfgMaxIndex 302 to 0x1 indicating two channels (numbered zero and one) will be alternated. Index 304 stores the current data word index that selects a routing configuration via routing mux 324 and, if the current data word index is greater than CfgMaxIndex 302, activate mute control 338 because no valid data will be passed for the out-of-bound current index value. Index 304 may increment on each DMA operation. CfgRouten 306 is a set of routing configuration registers, one for each available IHRₙ 308. When index 304 has a value of 0x0, configuration mux 324 routes the configuration parameters of CfgRoute0 to, for example, routing mux 326. This configurable routing allows data router circuit 300 to controllably reorder data streams. For example, if IHR0 receives left audio channel data and IHR1 receives right audio channel data, configurable routing via configuration mux 324 and routing mux 326 allows data router circuit 300 to send left channel data first and then right channel data or to send those values in reverse order to OHR 340. Configuration mux (multiplexer) 324 selects one of configuration registers CfgRouteₙ 306 based on current data word index 304 within a frame of data to be sent to the peripheral via OHR 340. Routing mux 326

Error signals 332 may be mapped to general purpose input/output (GPIO) pins 336 via error mux 334 and used, for example, as early mute signals for codecs in audio applications to prevent erroneous data from being played back at the media interface.

Data may be streamed through system 100 by DMA transfer for speed and efficiency. Data router circuit 300 receives data that has been extracted from network packets and stored in buffer 107. In one example, consider two streams of audio data with each comprising a left and right channel. These streams of data must be transferred to media interface 110, for example, over a four channel TDM connection. In this example, data transfers are 32-bit words. If a single stream were present, that single stream could be loaded via DMA payload into the I2S buffer. When multiple streams are present, simple DMA is insufficient even with striding or other options. Instead, data router circuit 300 combines streams for transfer to media interface 110 or an output buffer. In FIG. 3, each IHRₙ 308 represents a stream with associated configuration information in configuration route buffers 306. Each stream may have a repeating sequence of data units.

Data router circuit 300 may route streams arriving at IHR₀ . . . . IHRₓ to OHR 340 for subsequent transmission to a media device (not shown). In one example, 24-bits of data from a L Channel of an audio stream at IHR₁. If selectors 326 and 328 select IHR₁ for transmission, the 24 bits plus 8 bits of padding data from padding mask 318 may be routed through selector 326 to OHR 340. Mute control 338 and null input 336 may provide mechanisms for zeroing out data in the event of timing errors or missing stream data. In another example, 32 bits of data in buffer 107 may represent 8 bits of data in each of four channels of audio. Unpacker 310 may be used to unpack consecutive media data samples of a channel from an incoming packed memory buffer to optimize and assist the DMA transfers moving packed media data samples from the memory buffer to the unpacker input of the related channel. For example, unpacker 310 may unpack the four 8-bit portions and route those portions to four different selectors 326 as though each channel arrived at a different IHR 308. In some examples, unpacker 310 may be an additional IHR 308. In some examples, each IHR 308 may include unpacker circuitry to unpack data from that IHR. In this example, padding mask 318 would mask out the other 24 bits in each stream. Unpacker 310 may be configurable to unpack data in various ways. For example, an 8-bit chunk might be routed to the least significant bits of a 32-bit word or the most significant bits or some other arrangement as needed. In another example with three 8-bit data streams (e.g., L and R channels plus a subwoofer channel), unpacker 310 may take two cycles to unpack 32 bits of data. In a first cycle, unpacker 310 may unpack 8-bit chunks for each of the L channel, R channel, and sub channel. In the second cycle, unpacker 310 may unpack the fourth 8-bit chunk as an L channel value. In the second cycle, unpacker 310 may retrieve another 32-bit word from buffer 107 and read an 8-bit chunk for R channel and an 8-bit chunk for the sub channel. In some examples, unpacker 310 operates on single byte chunks within a four-byte word. In another example, unpacker 310 may unpack 24-bit audio samples per channel. In a first cycle, unpacker 310 may unpack a first 24-bit audio sample of an audio channel from a first word retrieved from buffer 107 and unpack the remaining 8 bits into a subsequent 24-bit audio sample of the same audio channel. In a second cycle, unpacker 310 may unpack 16 bits of a second word retrieved from buffer 107 and complete the subsequent audio sample from the same channel.

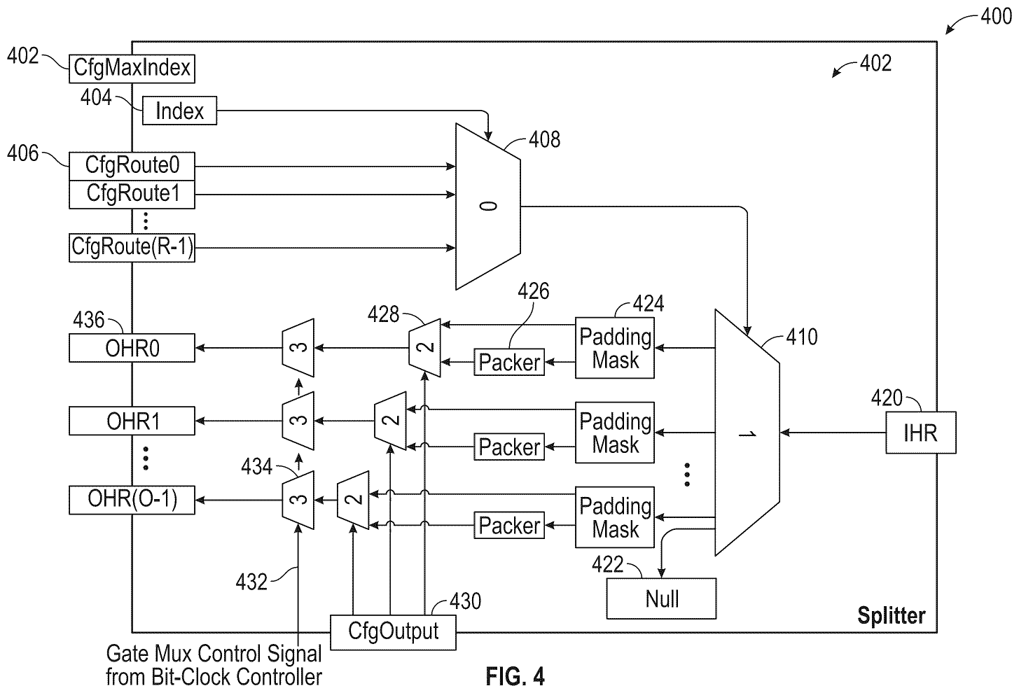

FIG. 4 is a diagram of an in-bound data router circuit 400, according to certain examples of the present disclosure. Data router circuit 400 may enable the division of data from the same peripheral interface into different network streams without software involvement. Data router circuit 400 may be completely driven by peripheral DMA transactions. Data router circuit 400 may also perform real-time error handling in communication with buffer monitor 114. Buffer monitor 114 may be configured to trigger a processor interrupt to quickly notify media packet processing 106 of an error condition to enable swift response in the form of a data restart message to the talker or a mute signal to media interface 110. In some examples, media packet processing 106 may terminate processing of non-critical data streams to prioritize critical data streams (such as that driving turn signals, brake lights, and driver warning displays). Data router circuit 400 may incorporate data value manipulation and reordering. The Receive Holding Register (RHR) of a peripheral may be connected via a DMA channel to the Input Holding Register (IHR) of data router circuit 400. A DMA channel may connect, for example, one of the Output Holding Registers (OHR) of data combiner 400 with data buffer 107. When software has prepared stream packet buffers, the software may initiate start of transmission by enabling the transmit start in the Bit-Clock Controller, that enables the Gate Open signal to data router circuit 400 and may enable the synchronization signal for the Timestamper used by the stream packet control. This signal may be required for synchronization of presentation timestamps and data words.

In-bound data router circuit 400 may operate like an out-bound data router circuit, but in reverse. Time-synchronous data may be received at input holding register (IHR) 420 from a media interface (e.g., via a 12S connection to a microphone sampling circuit or a PDM to PCM converter). At each pulse of a media clock, IHR 420 may receive a frame of data. For example, in an example with two microphones sampled, e.g., one microphone to the left of the windshield and one microphone in the center of the headliner, each frame of data may include a sample of each microphone. CfgMaxIndex 402 may store the highest valid index value. In an example that samples two microphone channels, CfgMaxIndex 402 may be set to 0x1 indicating two valid index values: 0x0 and 0x1, or 0 and 1 in base ten numbers. (It is common for digital circuit engineers to start counting at zero.) Index 404 may represent the currently active index. In an example that samples two microphone channels, index 404 may be 0x0 at the start of the media clock and increment to 0x1 before the next media clock pulse. In an example with four microphones, index 404 may cycle from 0x0 to 0x3 between media clock pulses. Index 404 selects, via configuration mux 408, a configuration register value from one of registers CfgRoute_{N} 406. Each register CfgRoute_{N} 406 may provide configuration settings for a single channel of time-synchronous data. For example, register CfgRoute₀ 406 may select a route for the first record in a frame of data received at IHR 420. In some examples, data router circuit 400 may reorder audio samples by routing the first sample of each frame to OHR1 and the second sample to OHR0. Each register CfgRoute_{N} 406 may also set padding mask 424 to pad certain bits of a sample such as the top eight bits of a 32-bit value where the audio sample is a 24-bit value. Padding mask 424 may pad a record by zeroing the padded bits. Padding mask 424 may pad a record by setting the padded bits to some specific pattern or value. CfgRoute_{N} 406 may configure packer 426 to pack audio samples more densely, for example, if two audio samples received from IHR 420 only contain 16-bits of data in each 32-bit transfer, CfgRoute₀ may load the 16-bit first sample in the first sixteen bits of a holding register within packer 426 and CfgRoute₁ may load the 16-bit second sample in the second sixteen bits of the holding register within packer 426. Each register CfgRoute_{N} 406 may set (via CfgOutput 430, or the output of configuration mux 408) output mux 428 to select either the output of padding mask 424 or packer 426 to pass towards the corresponding OHR 436. Gate mux control signal 432 provides a common input to gate muxes 434 to control the timing of transfer of a record in the frame of data received from IHR 420 to one of OHR 436 by enabling data to pass through gate muxes 434. For example, if each frame of data received at IHR 420 includes three 24-bit audio samples that are not reordered or packed, gate mux control signal 432 will be asserted three times each frame. The first time gate mux control signal 432 is asserted, gate mux 434 will pass the first sample (padded by padding mask 424) to be loaded into OHR0. Once OHR0 436 is loaded, index 404 is incremented and a DMA transaction trigger (not shown) is output to cause the DMA to transfer value of OHR0 to the buffer for subsequent transmission over the network to a consumer of that data. The second time gate mux control signal 432 is asserted, gate mux 434 will pass the second sample (padded by padding mask 424) to be loaded by OHR1. Once OHR1 is loaded, index 404 is incremented and a DMA transaction trigger (not shown) is output to cause the DMA to transfer value of OHR1 to the buffer for subsequent transmission over the network to a consumer of that data. The third time gate mux control signal 432 is asserted, gate mux 434 will pass the third sample (padded by padding mask 424) to be loaded by OHR2. Once OHR2 is loaded, index 404 is reset and a DMA transaction trigger (not shown) is output to cause the DMA to transfer value of OHR2 to the buffer for subsequent transmission over the network to a consumer of that data. This will repeat every frame of data. In some examples, routing mux 410 may discard a data record by routing the record from IHR 420 to null 422.

Data router circuits 300 and 400 may be used with many applications having multiple sources and one destination or one source and multiple destinations. In some applications a timing error may result in a mute function. In some applications, a timing error may result in a repeat of the last valid value. In some applications, a timing error may result in some other pattern output instead of the missing or mistimed value.

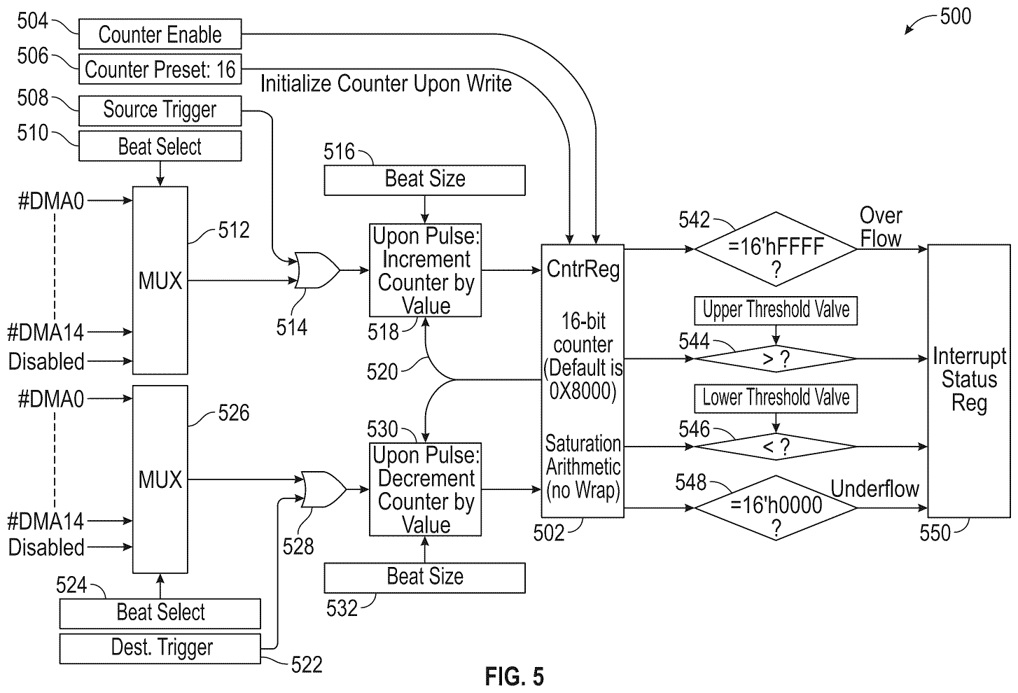

FIG. 5 is a diagram of buffer monitor 500, according to certain examples of the present disclosure. Buffer monitor 500 monitors the utilization level of a buffer/queue. Buffer/queue may be implemented in an SRAM or in a set of SRAMs. Buffer monitor 500 may detect underflow and/or overflow conditions. Adjustable thresholds may enable early detection of buffering issues. Buffer monitor 500 may be linked to data router circuit 108 for securing data routing. Buffer monitor 500 may observe ratios of data written and read in buffer 107. Buffer 107 may operate as a ring buffer with buffer monitor 500 observing overflow, near overflow, near underflow, and underflow conditions.

Buffer monitor 500 may observe a buffer for a single time-synchronous media channel, which may correspond to specific DMA channels. Buffer monitor 500 may operate by observing DMA read and write transactions on that DMA channel to count outflows and inflows, respectively. Counter 502 may store a current count as a positive integer value. Counter enable 504 may enable monitoring of the buffer by enabling counter 502. Counter preset 506 may provide an initial value of counter 502. Source trigger 508 may enable counting of buffer inflow transactions by enabling data to pass through OR gate 514. Beat select 510 identifies a DMA channel to observe via multiplexer 512. Beat size register 516 provides an increment value for each DMA transaction. Adder 518 combines the current value of counter 502 with the increment value in beat size register 516 to provide a new value of control register 502 when a data record is written to the buffer.

Similarly, destination trigger 524 may enable counting of buffer outflow transactions by enabling data to pass through OR gate 528. Beat select 524 identifies a DMA channel to observe via multiplexer 526. Beat size register 532 provides a decrement value for each DMA transaction. Adder 530 combines the current value of counter 502 with the decrement value (a negative value) in beat size register 532 to provide a new value of control register 502 when a data record is read from the buffer.

Overflow indicator 542 may be asserted when counter 502 equals the maximum integer allowable, or 0xFFFF for a 16-bit counter. Overflow indicator 542 may be stored in interrupt status register 550. Upper threshold indicator 544 may be asserted when counter 502 is greater than an upper threshold value and may be stored in interrupt status register 550. Underflow indicator 546 may be asserted when counter 502 is less than a lower threshold value and may be stored in interrupt status register 550. Underflow indicator 548 may be asserted when counter 502 is zero and may be stored in interrupt status register 550. Interrupt status register 550 may trigger a processor interrupt when any status values are written to report the status change to monitoring software. In some examples, a threshold indicator may trigger the software program to determine why data is arriving at a different rate than it is being processed and make adjustments. A buffer underflow or overflow condition may trigger the software program to reset a data flow. For example, if an audio stream on a channel causes an underflow or overflow, the audio data cannot be trusted and any audio output may be muted until the channel can be reset.

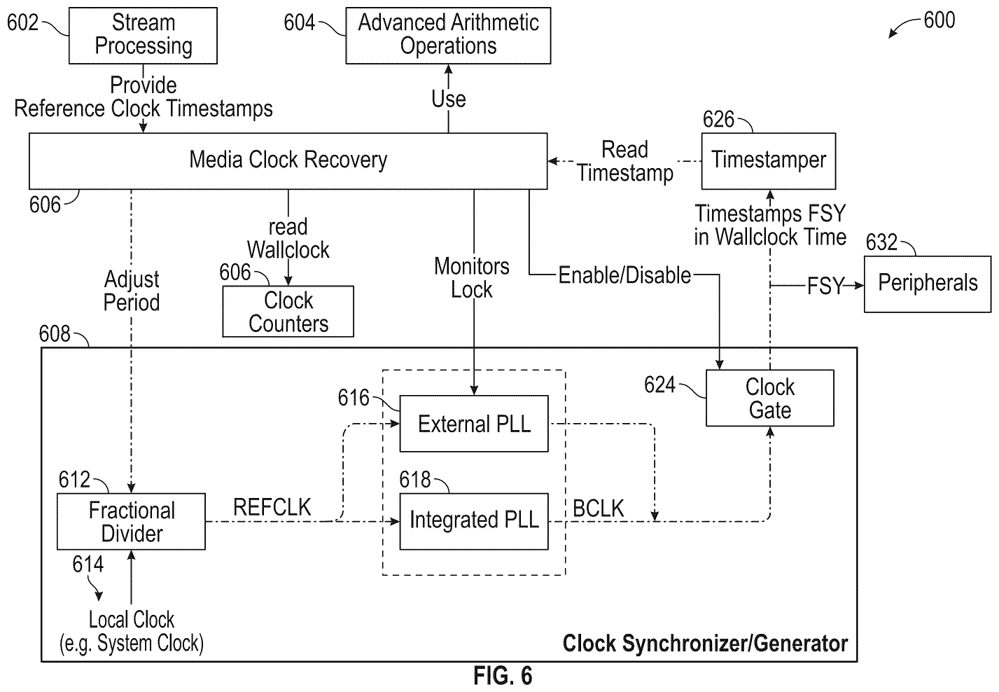

FIG. 6 is a diagram of media clock generation/recovery circuit 600, according to certain examples of the present disclosure. A software and hardware implemented control-loop may enable a precise, low-cost clock recovery solution. Media clock generation/recovery circuit 600 may operate on a Precision Time Protocol (PTP)-based clock reference stream. Media clock generation/recovery circuit 600 may interact with periphery synchronization such as I2S, Time Division Multiplexed (TDM) audio, pulse-density modulation (PDM) audio, a video frame clock, digital input/output pin sampling, serial communication clock synchronization, and/or synchronized DMA transfers.

Media clock generation/recovery circuit 600 provides a precise, low-cost clock recovery approach. The media clock may be recovered based on an incoming data stream received from the network. In conjunction with logic elsewhere in the present disclosure, the clock counters provide an efficient approach to tracking data timing and recovering clock synchronization in the event of a timing failure. This approach maintains current time rather than computing differences from some system clock time.

Stream processing 602 may extract reference clock timestamps from incoming time-synchronous media records. Advanced arithmetic operations 604 may perform filtering algorithms on the timestamps from the stream for use in adjusting the media clock reference smoothly without discontinuities. Media clock recovery 606 may be a software module observing reference clock timestamps and using advanced arithmetic operations 604 and a filtering algorithm to provide a period adjustment signal to clock synchronizer/generator 608. Clock synchronizer/generator 608 may generate a clock signal for use by timestamper 626 and as a media clock for peripherals 632. Clock synchronizer/generator 608 receives local system clock 614 and, via fractional divider 612, reduces the frequency to provide a reference clock. The outputs of PLLs 616 and 618 are controllably passed through to provide one or more clock signals to peripherals 632 and timestamper 626. For example, one such clock signal provided to peripherals 632 and timestamper 626 may be a frame synchronization signal (FSY).

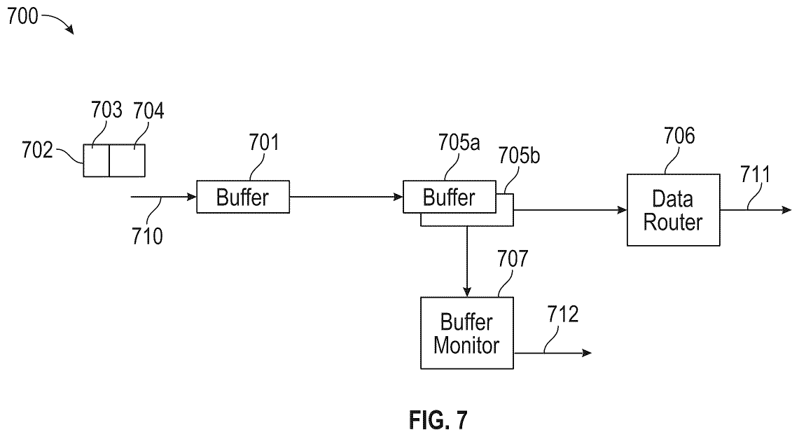

FIG. 7 is a diagram of a circuit for transferring streaming data from a network to a media interface (or in reverse), according to certain examples of the present disclosure. Circuit 700 includes buffer 701, buffers 705a and 705b, data router 706, buffer monitor 707, network interface connection 710, media interface connection 711, and processor interrupt interface 712. Buffer 701 may be a memory for storing instances of network messages 702 received from network interface connection 710. Each network message 702 may contain header portion 703 and data payload portion 704. Header portion 703 may include information such as a stream identifier and timestamp information. Data payload portion 704 may include encoded data such as audio information encoded in digital form such as in a PDM or TDM format. Buffers 705a and 705b may correspond channels of streaming data. For example, buffer 705a may correspond to a left audio channel and buffer 706b may correspond to a right audio channel. Each of buffers 705a and 705b stores stream data extracted from data payload portion 704 as network messages 702 are processed out of buffer 701. In some examples, buffers 705a and 705b are implemented within a single memory. In some examples, buffers 705a and 705b may be implemented as separate memories. Data router 706, in sync with a media clock, removes a data packet payload 704 from buffer 705a via a DMA transfer request and transfers it via media interface connection 711 to a media interface device such as an 12S bus interface. Triggered by the DMA transfer, buffer monitor 707 decrements a counter corresponding to buffer 705a. Data router 706, in sync with the next pulse of the media clock, removes a data packet payload 704 from buffer 705b via a DMA transfer request and transfers it via media interface connection 711 to the media interface device. Triggered by the DMA transfer, buffer monitor 707 decrements a counter corresponding to buffer 705b. Buffer monitor 707 increments the corresponding buffer as data packet payloads 704 are input into buffers 705a and 705b. When buffer monitor 707 detects a buffer underflow or overflow, buffer monitor 707 may assert processor interrupt interface 712 to interrupt the processor. The processor may then determine the cause of the buffer underflow/overflow situation and take corrective action.

Although example embodiments have been described above, other variations and embodiments may be made from this disclosure without departing from the spirit and scope of these embodiments.

What is claimed is:

1. An apparatus, comprising:
a buffer in direct memory access (DMA) communication with a network interface to receive data packets comprising data payload portions containing data in a stream of time-synchronous media,
a buffer to temporarily store a plurality of time-synchronous media records extracted from the data payload portions, wherein respective ones of the plurality of time-synchronous media records is associated with a respective media channel,
a data router circuit to read one of the plurality of time-synchronous media records from the buffer route that time-synchronous media record to a media interface, and
a buffer monitor circuit to monitor a ratio of stored records and read records and to trigger a processor interrupt in the event of a buffer underflow or buffer overflow.

2. The apparatus of claim 1, comprising:
a timestamp matching circuit, comprising:
a timestamp window representing a minimum timestamp value and a maximum timestamp value,
a timestamp register to record a time value corresponding to a most recent frame synchronization signal, and
a matching circuit to assert a match signal when the time value corresponding to the most recent frame synchronization signal is within the timestamp window.

3. The apparatus of claim 2, the timestamp matching circuit comprising:
a first counter to increment on each operation of the matching circuit, and
a latched counter to increment on each assertion of the match signal.

4. The apparatus of claim 3, the timestamp matching circuit comprising:
a reset circuit to reset the first counter and the latched counter, and to set a trigger to enable the first counter on a next assertion of the match signal.

5. The apparatus of claim 1, the data router circuit comprising:
a first DMA input associated with a first media channel to receive a first time-synchronous media record from the buffer,
a second DMA input associated with a second media channel to receive a second time-synchronous media record from the buffer,
an unpacker circuit for receiving a third time-synchronous media record from the buffer, the unpacker circuit comprising:
a first unpacker output to output a first subset of the third time-synchronous record, and
a second unpacker output to output a second subset of the third time-synchronous record,
a first input selector to select either the first DMA input or the first unpacker output, and
a second input selector to select either the second DMA input or the second unpacker output.

6. The apparatus of claim 5, the data router circuit comprising:
a gate closed input,
a first gate selector to select either the output of the first input selector or the gate closed input based on a first gate control signal, and
a second gate selector to select either the output of the second input selector or the gate closed input based on a second gate control signal.

7. The apparatus of claim 6, the data router circuit comprising:
a first padding mask circuit to controllably mask zero or more bits of the output of the first gate selector,
a second padding mask circuit to controllably mask zero or more bits of the output of the second gate selector, and
a routing selector to route to an output register one of:
an output of the first padding mask circuit,
an output of the second padding mask, and
a null value.

8. A method, comprising:
receiving a first time-synchronous media record containing data in a stream of time-synchronous media,
storing the first time-synchronous media record in a buffer with a media channel identifier and associated with a timestamp,
monitoring the buffer with a buffer monitor circuit to trigger a processor interrupt in the event of a buffer underflow or buffer overflow,
determining the timestamp to be within an acceptable timestamp window and
routing the first time-synchronous media record from the buffer to a media interface using a data router circuit, wherein the routing is based at least in part on the media channel identifier.

9. The method of claim 8, comprising:
incrementing a first counter on each occurrence of storing the data payload in the buffer, and
storing the first counter in a latched counter on each occurrence of determining the timestamp to be within an acceptable timestamp window.

10. The method of claim 9, comprising:
resetting the first counter and the latched counter, and
setting a trigger for enabling the first counter on a next occurrence of determining the difference between the current time and the timestamp to be less than the window.

11. The method of claim 8, comprising:
receiving, at a first DMA input associated with a first media channel, a first time-synchronous media record from the buffer,
receiving, at a second DMA input associated with a second media channel, a second time-synchronous media record from the buffer,
based on an input selector, selecting the second time-synchronous record to proceed through a routing circuit, and
subsequent to outputting the second time-synchronous record, selecting the first time-synchronous record to proceeded through the routing circuit.

12. The method of claim 8, comprising:
receiving, at a first DMA input associated with a first media channel, a first time-synchronous media record from the buffer,
based on a packer configuration input, selecting a first portion of the first time-synchronous media record to proceed through a routing circuit,
selecting by a first gate selector to route either a gate closed input or the first portion of the first time-synchronous record to proceed through a routing circuit, and
subsequent to selecting the first portion of the first time-synchronous media record to proceed through the routing circuit based on the packer configuration input, selecting a second portion of the first time-synchronous media record to proceed through the routing circuit.

13. The method of claim 12, comprising:
controllably masking eight or more bits of the first portion of the first time-synchronous record to generate a padded record, and
outputting the padded record to a media device.

14. An apparatus, comprising:
a buffer in direct memory access (DMA) communication with a network interface to send data packets comprising data payload portions containing data in a stream of time-synchronous media,
a buffer to temporarily store a plurality of time-synchronous media records to be included in data payload portions, wherein respective ones of the plurality of time-synchronous media records is associated with a respective media channel,
a data router circuit to route data between a media interface and the buffer, and
a buffer monitor circuit to monitor a ratio of stored records and read records and to trigger a processor interrupt in the event of a buffer underflow or buffer overflow.

15. The apparatus of claim 14, comprising:
a channel selector to route a data record from the media interface to one of a plurality of media channel registers, each media channel register in DMA communication with the buffer.

16. The apparatus of claim 15, comprising:
a plurality of padding mask circuits each padding mask circuit to controllably mask zero or more bits of a particular data record from the media interface before storing the padded data record in associated with one of the plurality of media channel registers.

17. The apparatus of claim 15, comprising:
a packer circuit in communication with the channel selector to combine at least a portion of each of two data records received from the media interface and to store the combination in one of the plurality of media channel registers.

18. A method comprising:
receiving a data record from a media device, the data record forming a portion of a stream of time-synchronous media,
routing the data record over a DMA channel to store the data record in a time-synchronous media buffer the time-synchronous media record associated with the media stream, and
monitoring the buffer with a buffer monitor circuit to trigger a processor interrupt in the event of a buffer underflow or buffer overflow.

19. The method of claim 18, comprising:
selecting a channel to route a time-synchronous media record from the media interface to one of a plurality of media channel registers, each media channel register in DMA communication with the buffer.

20. The method of claim 19, comprising:
controllably masking zero more bits of the data record.

21. The method of claim 19, comprising:
packing at least a portion of each of two data records received from the media device and storing the combination in one of the plurality of media channel registers.
